(19) United States
(12) Patent Application Publication
(10) Pub. No.: US 2022/0266487 A1
(43) Pub. Date: Aug. 25, 2022

(54) TWO-SHOT MOLDED TRANSFERRED PART WITH FILM DECORATION

(71) Applicant: SRG Global Liria, S.L., Liria (ES)

(72) Inventor: Pablo BAAMONDE LORENZO, Liria (ES)

(73) Assignee: SRG Global Liria, S.L., Liria (ES)

(21) Appl. No.: 17/677,135

(22) Filed: Feb. 22, 2022

(30) Foreign Application Priority Data
Feb. 23, 2021 (ES) P202130152

(51) Int. Cl. B29C 45/14; B29C 45/02; B29C 45/00

(52) U.S. Cl. CPC B29C 45/14688; B29C 45/02; B29C 45/0001; B29C 2045/14893; B29K 2069/00

(57) ABSTRACT

A method of for multi-shot injection molding of a transferred part with film decoration includes performing a first injection molding shot to form an opaque plastic portion and a protective film layer that collectively form a transferred part defining one or more apertures, and performing a second injection molding shot including the transferred part to form a transparent plastic portion on an A-side of the transferred part and a metallic film layer on a B-side of the transferred part. A multi-shot injection molded transferred part with film decoration includes an opaque plastic portion and a protective film layer that collectively form the transferred part defining one or more apertures, a transparent plastic portion on an A-side of the transferred part; and a metallic film layer on a B-side of the transferred part.

### CROSS-REFERENCE TO RELATED APPLICATION(S)

The present application claims the benefit of Spanish Application No. P202130152, filed on Feb. 23, 2021. The disclosure of the above-identified application is incorporated herein by reference in its entirety.

### FIELD

The present application relates to a process for two-shot (2K) injection molding of a transferred part with film decoration.

### BACKGROUND

Multi-shot injection molding (e.g., two-shot, or 2K injection molding) can be used to form decorative trims and the like for automotive applications. In order to provide a bright or metallic-like (e.g., chrome-like) finish, film decorations and other processed can be used. One non-limiting example of such an automotive application is a light detection and ranging (LIDAR) device. Conventional processes involve forming a plastic part (e.g., polycarbonate, or PC) and then applying paint or other materials in subsequent steps. These are relatively complex and costly by not being optimized. Thus, while conventional metallic finish LIDAR devices do work for their intended purpose, there remains a desire for improvement in the relevant art.

### SUMMARY

According to one aspect of the present disclosure, a method for multi-shot injection molding of a transferred part with film decoration is presented. In one exemplary implementation, the method comprises performing a first injection molding shot to form an opaque plastic portion and a protective film layer that collectively form a transferred part defining one or more apertures, and performing a second injection molding shot including the transferred part to form a transparent plastic portion on an A-side of the transferred part and a metallic film layer on a B-side of the transferred part.

In some implementations, the second injection molding shot is laterally adjustable such that the one or more apertures are arranged in desired positions. In some implementations, the lateral adjustability is achievable using movable inserts within a mold cavity. In some implementations, the lateral adjustability is achievable to compensate for shrinking. In some implementations, the opaque and transparent portions are each formed of polycarbonate (PC). In some implementations, the protective film layer is a colored film layer. In some implementations, the multi-shot injection molding comprises only two shots. In some implementations, the multi-shot injection molding comprises three or more shots.

According to another aspect of the present disclosure, a multi-shot injection molded transferred part with film decoration is presented. In one exemplary implementation, the part comprises an opaque plastic portion and a protective film layer that collectively form the transferred part defining one or more apertures, a transparent plastic portion on an A-side of the transferred part, and a metallic film layer on a B-side of the transferred part.

In some implementations, the transparent plastic portion and the metallic film layer are formed via laterally adjustment such that the one or more apertures are arranged in desired positions. In some implementations, the lateral adjustability is achievable using movable inserts within a mold cavity. In some implementations, the lateral adjustability is achievable to compensate for shrinking. In some implementations, the opaque and transparent portions are each formed of polycarbonate (PC). In some implementations, the protective film layer is a colored film layer. In some implementations, the multi-shot injection molding process to form the part comprises only two shots. In some implementations, the multi-shot injection molding process to form the part comprises three or more shots.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the substance of the present disclosure are intended to be within the scope of the present disclosure.

### BRIEF DESCRIPTION OF THE DRAWINGS

FIGS. 1A-1C illustrate example improved two-shot (2K) injection molding and film transfer processes according to some embodiments of the present disclosure; and

FIGS. 2A-2B illustrate example decorative parts or designs that could be formed utilizing the improved 2K injection molding and file transfer processes according to some implementations of the present application.

### DETAILED DESCRIPTION

According to some implementations of the present disclosure, an improved two-shot (2K) injection molding and film transfer process is presented. While 2K injection molding is specifically discussed herein, it will be appreciated that there could be three or more injection molding shots for more complex designs. As previously discussed, the problem with other decorations techniques is the accuracy of the processes that could be optimized via the process of the present disclosure. Alternative solutions for decoration are other combination of processes with more steps to get the same appearance, such as (1) PC plus paint on B-side and laser etching on B-side to remove paint in areas to be transparent, (2) PC plus pad printing, and (3) PC plus in-mold labeling (IML) or in-mold decorating (IMD), which refers to the process of decorating or labeling injection molded plastic parts or components during the plastic injection molding cycle. When the mold is closed, plastic resin is injected into the mold, encapsulating the label permanently within the finished part.

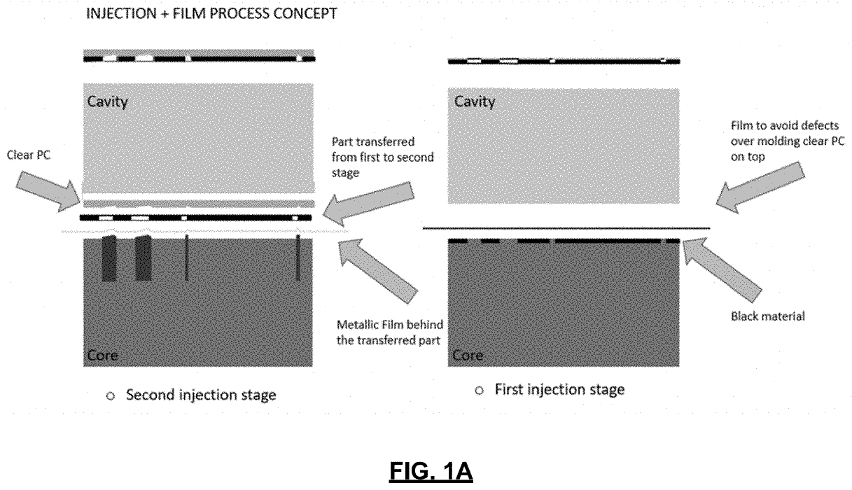

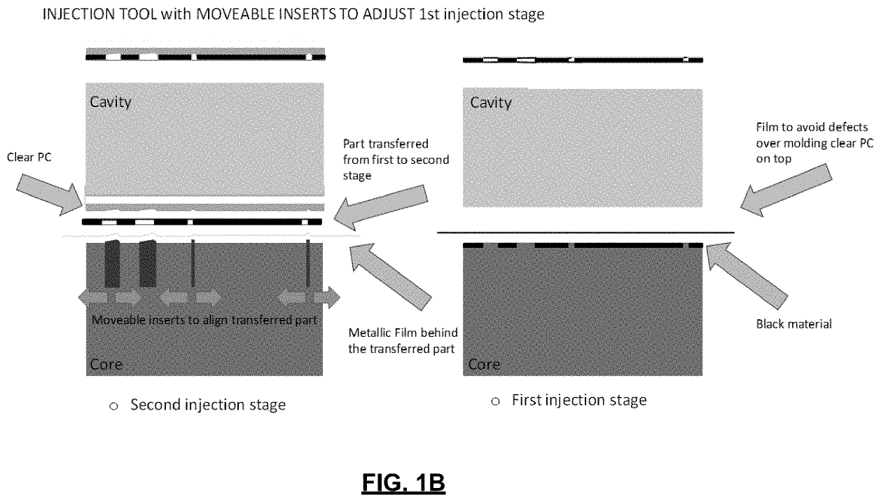

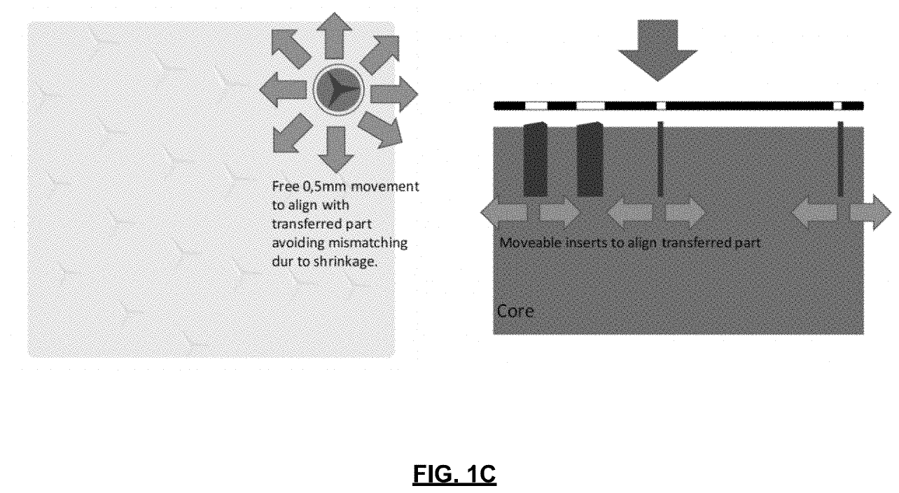

Referring now to FIGS. 1A-1B, example process or flow diagrams of the improved injection molding and film transfer processes according to some embodiments of the present disclosure is illustrated. The improved process of the present disclosure provides for full decoration of an injected molded part done in an injection molding machine (IMM) from the B-side. Process optimization is performed to reduce the number of steps to get the injected molded part complete decorated. 2K injected molding can include one or both shots being formed of a clear material, with decorative films applied for first and second stages. Prior to the solution, parts were 2K injected molded parts without decoration from the B-side.

One key aspect is the film being used in the first injection phase to decorate and/or protect washout while injecting clear material on top of black in second phase. More specifically, the first film decorates and protects films material and the second film decorates though the apertures or holes on the first injected part that is transferred to second phase. In the second phase, the film is key for this process to work in combination of part geometry. As shown, the process operates as a combination of transparent polycarbonate with other thermoplastic plus films to have a decoration done on B side. As previously discussed, conventional 2K injection molding processes already exist in the industry for many applications, but not IML from B side showing the film only through first injected part transferred to second phase. As a result, this process provides for complexity reduction doing all decoration processes in the IMM during the injection cycle.

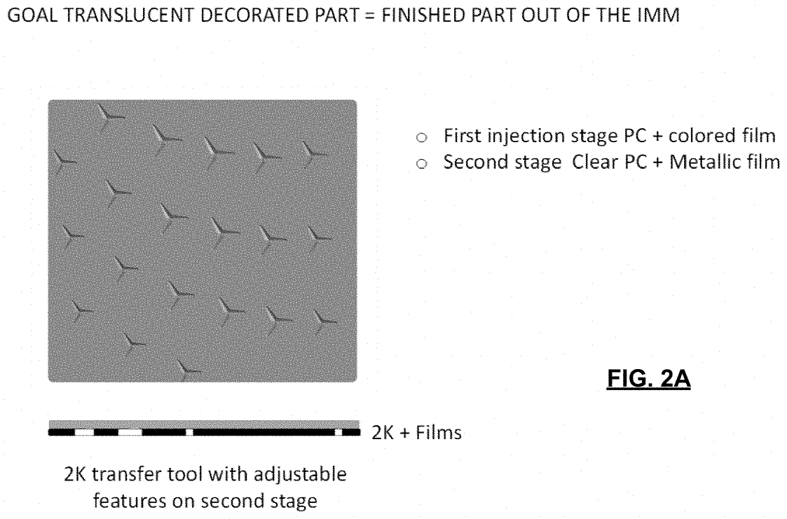

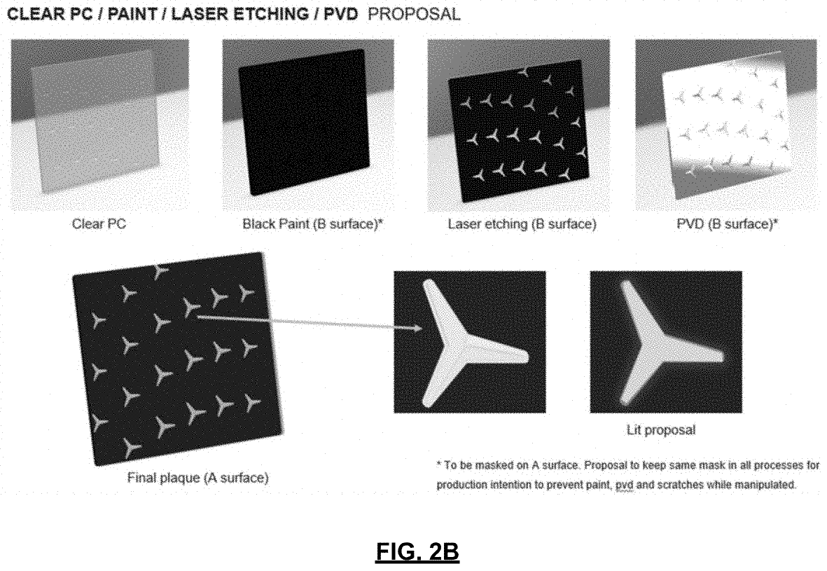

FIGS. 1B-1C specifically illustrate an alternate process or flow diagram where the injection tool has movable inserts to adjust the first injection stage. FIGS. 2A-2B also illustrate example decorative parts or designs that could be formed utilizing the improved 2K injection molding and file transfer processes according to some implementations of the present application. It will be appreciated that these are merely examples for illustrative purposes and should not limit the applicability of the improved 2K injection molding processes of the present disclosure.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of the example embodiments.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A method for multi-shot injection molding of a transferred part with film decoration, the method comprising:
performing a first injection molding shot to form an opaque plastic portion and a protective film layer that collectively form a transferred part defining one or more apertures; and
performing a second injection molding shot including the transferred part to form a transparent plastic portion on an A-side of the transferred part and a metallic film layer on a B-side of the transferred part.

2. The method of claim 1, wherein the second injection molding shot is laterally adjustable such that the one or more apertures are arranged in desired positions.

3. The method of claim 2, wherein the lateral adjustability is achievable using movable inserts within a mold cavity.

4. The method of claim 2, wherein the lateral adjustability is achievable to compensate for shrinking.

5. The method of claim 1, wherein the opaque and transparent portions are each formed of polycarbonate (PC).

6. The method of claim 5, wherein the protective film layer is a colored film layer.

7. The method of claim 1, wherein the multi-shot injection molding comprises only two shots.

8. The method of claim 1, wherein the multi-shot injection molding comprises three or more shots.

9. A multi-shot injection molded transferred part with film decoration, the part comprising:
an opaque plastic portion and a protective film layer that collectively form the transferred part defining one or more apertures;
a transparent plastic portion on an A-side of the transferred part; and
a metallic film layer on a B-side of the transferred part.

10. The part of claim 9, transparent plastic portion and the metallic film layer are formed via laterally adjustment such that the one or more apertures are arranged in desired positions.

11. The part of claim 10, wherein the lateral adjustability is achievable using movable inserts within a mold cavity.

12. The part of claim 10, wherein the lateral adjustability is achievable to compensate for shrinking.

13. The part of claim 9, wherein the opaque and transparent portions are each formed of polycarbonate (PC).

14. The part of claim 13, wherein the protective film layer is a colored film layer.

15. The part of claim 9, wherein the multi-shot injection molding process to form the part comprises only two shots.

16. The part of claim 9, wherein the multi-shot injection molding process to form the part comprises three or more shots.
